(19) United States
(12) Patent Application Publication
(10) Pub. No.: US 2009/0003591 A1
(43) Pub. Date: Jan. 1, 2009

(54) Quantum Cryptographic Communication Method

(75) Inventors: Yumiko Murakami, Kamakura-shi (JP); Masaki Nakanishi, Ikoma-shi (JP); Shigeru Yamashita, Kyoto-shi (JP)

Correspondence Address: OLIFF & BERRIDGE, PLC, P.O. BOX 320850, ALEXANDRIA, VA, 22320-4850, US

(73) Assignee: NATIONAL UNIVERSITY CORPORATION NARA INSTITUTE OF SCIENCE AND TECHNOLOGY, Ikoma-shi (JP)

(21) Appl. No.: 12/224,625

(22) PCT Filed: Feb. 15, 2007
(86) PCT No.: PCT/JP2007/000086

§ 371 Date: Sep. 2, 2008

(30) Foreign Application Priority Data
Mar. 6, 2006 (JP) 2006-058933

(51) Int. Cl. H04L 9/00; H04L 9/28

(52) U.S. Cl. 380/28; 380/255

(57) ABSTRACT

A sender (1) adds decoy photons to a secret photon having confidential information, then, subjects each photon to a different rotational manipulation, and passes the photons along a quantum channel (3) (S11 and S12). A receiver (2) receives those photons and then obtains information about the position of the decoy photons from the sender (1) through a classical channel (4). Using the information, the receiver (2) subjects each of the decoy and secret photons to a different rotational manipulation and transmits the photons in a rearranged order (S13 and S14). The receiver (1) obtains information about the position and manipulation quantities of the decoy photons from the receiver (2) and decodes the decoy photons. If the quantum state of the decoys is identical to their initial quantum state, the sender (1) determines that no eavesdropper (5) should be present (S15 and S16), cancels only the encryption of the secret photon performed by himself or herself in S12, and transmits the secret photon (S17). The receiver (2) cancels the encryption of the secret photon performed by himself or herself in S13 and thereby obtains the confidential information (S18). The present method can securely send quantum information as well as classical information such as key information, and also effectively detect eavesdropping.

### TECHNICAL FIELD

The present invention relates to a quantum cryptographic communication method for communicating confidential information by using quantum cryptography.

### BACKGROUND ART

With the rapid progress of wired and wireless network communications and steep increase in their usage in recent years, the problem of information security is becoming more and more important, and its importance is expected to further increase in the future. One of the critical technologies supporting information security is cryptographic technology. Current cryptographic technologies can be divided into two types: secret-key cryptography, such as DES (data encryption standard), and public-key cryptography, such as RSA (Rivest, Shamir, Adleman). Secret-key cryptography uses the same key for both encryption and decryption. This technology is associated with the problem of key distribution, i.e. the problem of how to securely send the key to the receiver. On the other hand, public-key cryptography uses different keys for encryption and decryption; the sender encrypts confidential information with a key published by the receiver, while the receiver can decrypt the code with a secret key, which is known exclusively by the receiver. Thus, this technology is advantageous in that it is free from the key distribution problem.

RSA cryptography is a kind of public-key cryptography. Although its encoding algorithm has been cracked, its computational security is guaranteed since the algorithm includes prime factorization of a number with many digits, which requires an astronomical period of time even if a high-speed computer is used. For this reason, this encryption scheme is currently widely used. However, it is pointed out that the computational security of the current method will possibly be endangered when quantum computers, which are capable of performing computations much faster than conventional computers, are put into practical application in the future.

In such a situation, quantum cryptography is attracting attention as a cryptographic technology ensuring higher levels of security than those offered by the current cryptographic schemes mentioned earlier (which are hereinafter called the classical cryptography). The quantum cryptography is a technology whose security is not the computational security but information quantitative security derived from the Heisenberg uncertainty principle, which is a basic principle of quantum mechanics. Owing to this feature, quantum cryptography is recognized as a technique that will not be cracked even by practical application of quantum computers. Currently proposed protocols for quantum cryptography can be classified into two major types. One type performs the key distribution, and the other uses public-key cryptosystems.

The first type is a protocol for securely sharing only a key to be used in cryptographic communications. There have been many proposals for this type, including the one called “BB84” (refer to Non-Patent Document 1 or other documents), and they have been proven to be unconditionally secure. The second type also has several protocols, including the one proposed by Okamoto et al. (Non-Patent Document 2) or Kawachi et al. (Non-Patent Document 3). These protocols have been proven to be as difficult to crack as some problems that are considered as difficult to efficiently solve even if a quantum computer is used.

However, quantum cryptography communications using the aforementioned conventional quantum cryptography schemes have the following problems:

(1) Quantum cryptography communication systems are generally supposed to use photons as the information carrier, with each photon carrying a separate piece of information and being passed from a sender to a receiver through optical fibers or similar communication channels. In this case, each photon represents quantum information by its direction of polarization. For example, in a conventional version of quantum cryptography, information is communicated by associating one bit, 0 or 1, with the vertical or horizontal polarization (or diagonal or anti-diagonal polarization) of the photon. That is, the method can practically transmit only the classical binary information (0 or 1); it cannot send quantum information despite the use of a quantum-theoretical particle, i.e. photon.

(2) The key distribution protocols, represented by BB84, are guaranteed to be unconditionally secure. However, they can be used only for key distribution. Other items of information need to be encrypted using the distributed key and sent through classical channels.

(3) In the aforementioned key distribution protocols, one bit of information needs to be carried by a single photon. However, it is difficult for practically-realizable devices to manipulate a specific single photon; unfortunately, they allow multiple photons having the same information to flow into the communication channel. The guaranteed high security is premised on the quantum-theoretical fact that any single photon cannot be cloned without losing the information it carries. However, this premise will be lost if multiple photons having the same information flow through the channel; this situation will allow an interceptor (eavesdropper) to catch a portion of the photons without the receiver's knowledge, which may possibly result in a leakage of information.

(4) In addition to the aforementioned key distribution protocols, a method for quantum secure direct communication is also proposed. This method is not intended for key distribution; it can directly send any kind of information, using photons as the carrier. However, this method does not differ from the aforementioned key distribution protocols in that it can only send classical information. Another problem is that the method is extremely difficult to implement since it requires precise handling of a photon pair having a special quantum state called an “entanglement”.

Non-Patent Document 1: C. Bennett et al., “Quantim Cryptography: Public key distribution ando coin tossing”, Proc. IEEE International Conf Computers Systems, and Signal Processing, 1984, pp. 175-179.

Non-Patent Document 2: Kawachi et al., “Computational Indistinguishability between Quantim States and Its Cryptographic Application”, Proc. of EuroCrypt 2005, LNCS 3494, 2005, pp. 268-284.

### DISCLOSURE OF THE INVENTION

### Problem to be Solved by the Invention

The present invention has been developed in view of these problems. Its first objective is to provide a quantum cryptographic communication method capable of sending not only classical information but also quantum information.

The second objective of the present invention is to provide a quantum cryptographic communication method capable of more securely transmitting information and also detecting interception (eavesdropping) by a third party with high probability.

The third objective of the present invention is to provide a quantum cryptographic communication method that can maintain its security level even if multiple photons have been accidentally sent into a communication channel as a result of unsuccessful manipulation of a specific single photon (or other kinds of quantum-theoretical particles).

The fourth objective of the present invention is to provide a quantum cryptographic communication method that can be implemented in a relatively easy manner.

### Means for Solving the Problems

To achieve the first, third and fourth objectives, a first aspect of the present invention provides a quantum cryptographic communication method for performing communication using quantum cryptography in sending confidential information from a sender side to a receiver side through a communication channel, which is characterized in that:

a photon is used as a qubit;

a rotational manipulation for changing the deflection angle of the photon is used as a quantum manipulation for changing the quantum state of the qubit; and

the following steps are sequentially performed:
a sender-side sending step, including: subjecting a single secret qubit with confidential information placed thereon to encryption by the quantum manipulation of a randomly determined quantity for changing the quantum state of the secret qubit, and then passing the secret qubit along a quantum channel in order to send the secret qubit to the receiver side;
a receiver-side returning step, including: subjecting the secret qubit received through the quantum channel to encryption by the quantum manipulation of a randomly determined quantity for changing the quantum state of the secret qubit, and then passing the secret qubit along the quantum channel in order to return the secret qubit to the sender side;
a sender-side resending step, including: subjecting the secret qubit returned to the sender side to a reverse manipulation by the aforementioned quantity for decrypting the encryption performed earlier on the sender side, and then passing the secret qubit along the quantum channel in order to resend the secret qubit to the receiver side; and
a receiver-side receiving step, including: subjecting the secret qubit received through the quantum channel to a reverse manipulation by the aforementioned quantity for decrypting the encryption performed earlier on the receiver side, and then obtaining the confidential information placed on by the qubit.

A second aspect of the present invention, which has been developed to achieve the first, third and fourth objectives, is basically the same as the first aspect of the present invention except that the quantum manipulation for changing the quantum state of the qubit uses a manipulation represented by a matrix operation in which the qubit is multiplied by one of a plurality of matrices prepared beforehand.

In the quantum cryptographic communication methods according to the first and second aspects of the present invention, an optical fiber or similar optical communication channel can be used as the quantum channel since a photon is used as the qubit.

### Effects of the Invention

In the quantum cryptographic communication methods according to the first and second aspects of the present invention, any qubit passing through the quantum channel is always in an encrypted state, i.e. in a state produced by a random manipulation or manipulations performed by one or both of the sender and the receiver. Thus, the qubit is in the maximally mixed state, which means that if an eavesdropper could observe a qubit flowing through the quantum channel, the interceptor would not be able to acquire information from that qubit. Prior exchange of the secret decryption keys is unnecessary since neither the sender nor receiver needs to know the quantity of the manipulation carried out by the other party (this quantity corresponds to the secret key for encryption and decryption).

Thus, the quantum cryptographic communication methods according to the present invention can transmit confidential information with information quantitative security, i.e. in an unconditionally secure manner, without sharing secret keys beforehand between the sender and the receiver. Before being encrypted, the qubit may be in any quantum state (which may be in an unknown state). Accordingly, any kind of quantum information can be placed on the qubit for transmission. It is of course possible to send classical binary information by associating two different quantum states with “0” and “1” before encryption, respectively.

The quantum cryptographic communication methods according to the present invention ensure high security levels even if the photons, each of which should correspond to one qubit, cannot be individually and exactly passed along the quantum channel and multiple photons having the same confidential information are transmitted. This is because the quantum cryptographic communication methods according to the present invention do not require exchanging secret keys between the sender and the receiver; even if an eavesdropper has successfully caught one of the multiple photons, the eavesdropper cannot extract confidential information since the interceptor cannot obtain the secret keys. Since there is no need to individually and exactly pass photons along the quantum channel, the present methods can be advantageously implemented with easier restrictions concerning hardware configurations.

To achieve the second objective, in the quantum cryptographic communication method according to the first or second aspect of the present invention, it is preferable that:

an authenticated classical channel through which a sender and a receiver can communicate with each other is provided in addition to the quantum channel;

the sender-side sending step includes: preparing n pieces of decoy qubits (where n is an integer including one) for each secret qubit, subjecting not only the secret qubit but also each decoy qubit to the quantum operation of a randomly determined quantity for changing the quantum state of each qubit, and sequentially passing a total of n+1 pieces of qubits in an arbitrary order along the quantum channel;

the receiver-side returning step includes: receiving the n+1 pieces of qubits through the quantum channel, then obtaining bit sequence information from the sender through the classical channel, subjecting each of the secret qubit and decoy qubits to the quantum operation of a randomly determined quantity for changing the quantum state of each qubit, and passing the qubits in an arbitrarily rearranged order along the quantum channel in order to return them to the sender side; and

the sender-side resending step includes: receiving the n+1 pieces of qubits through the quantum channel, then obtaining bit sequence information and quantity information of the manipulation performed on each decoy qubit from the receiver through the classical channel, decoding each decoy qubit by a reverse manipulation for canceling both the quantum operation performed earlier on the sender side and the quantum operation performed on the receiver side, and checking for evidence of eavesdropping by determining whether or not the quantum state of the decoded decoy qubit is identical to the initial quantum state thereof.

In this quantum cryptographic communication method, any third party who impersonates a receiver to obtain confidential information has to correctly guess the position of the decoy qubits, which are appropriately mixed in temporal sequence, to successfully pass through the check of the decoy qubits. Increasing the number of decoy qubits (i.e. increasing the value of n) results in a higher probability of an unsuccessful guess, namely, a higher probability of detecting eavesdropping. Thus, the communication security is improved.

In order to further increase the probability of detecting eavesdropping, it is preferable that the eavesdropper be forced to guess the position of the decoy qubits multiple times and the eavesdropping activity be detected if the guessed results are not all correct. That is, in the quantum cryptographic communication methods according to the present invention, the n+1 pieces of qubits may be bi-directionally transmitted through the quantum channel multiple times by repeating the following steps:

subjecting each of the secret qubit and decoy qubits to the quantum operation of a randomly determined quantity for changing the quantum state of each qubit, and then sequentially passing the n+1 pieces of qubits in an arbitrarily rearranged order along the quantum channel, if no evidence of eavesdropping has been found in the sender-side resending step;

on the receiver side, receiving the qubits, then obtaining bit sequence information from the sender through the classical channel, subjecting each of the secret qubit and decoy qubits to the quantum operation of a randomly determined quantity for changing the quantum state of each qubit, and sequentially passing the qubits in an arbitrarily rearranged order along the quantum channel in order to return the qubits to the sender side; and

on the sender side, checking for evidence of eavesdropping by the same process as in the sender-side resending step.

The security level can be further enhanced by checking for evidence of eavesdropping not only on the sender side but also the receiver side when the secret qubit is finally transmitted after the sender-side encryption has been cancelled. That is, the quantum cryptographic communication method according to the present invention may preferably include:

on the sender side, in the case of no detection of an eavesdropping activity a predetermined number of times in series, subjecting the secret qubit to a reverse manipulation for canceling the entire encryption performed earlier on the sender side and each decoy qubit to the quantum operation of an arbitrary quantity for changing the quantum state of the decoy qubit, and then sequentially passing the n+1 pieces of qubits including the secret qubit in an arbitrary order along the quantum channel; and

on the receiver side, receiving the aforementioned photons, then obtaining information about the qubit sequence, the quantity of the manipulation performed on each decoy qubit, and an initial quantum state of each decoy qubit from the sender, decoding each decoy qubit by a reverse manipulation for canceling the quantum operation performed by the sender, then checking for evidence of eavesdropping by determining whether or not the quantum state of the decoded decoy qubit is identical to the initial quantum state thereof, and subjecting the secret qubit to a reverse manipulation for canceling the entire encryption performed on the receiver side, if no evidence of eavesdropping has been found.

In the case where some information is obtained through the classical channel after the qubits are transmitted through the quantum channel as described previously, it is necessary to provide a quantum memory for holding each qubit received and maintaining its quantum state. However, if the provision of a quantum memory is obstructive to the implementation of the present method, it is possible to use a method that does not require any quantum memory.

In a specific example of such a method:

an authenticated classical channel through which a sender and a receiver can communicate with each other is provided in addition to the quantum channel;

n+1 pieces of qubits (where n is an integer) are sent and received through the quantum channel multiple times by repeating the following steps:
in the sender-side sending step, preparing n pieces of decoy qubits for each secret qubit, subjecting each of the secret qubit and decoy qubits to the quantum operation of a randomly determined quantity for changing the quantum state of each qubit, and sequentially passing a total of n+1 pieces of qubits in an arbitrary order along the quantum channel;
in the receiver-side returning step, receiving the n+1 pieces of qubits through the quantum channel, then subjecting each qubit to the quantum operation of a randomly determined quantity for changing the quantum state of each qubit, and passing the qubits along the quantum channel in order to return the qubits to the sender side;
in the sender-side resending step, receiving the n+1 pieces of qubits through the quantum channel, then guessing the quantity of the manipulation performed on each decoy qubit on the receiver side, performing an observation based on the guessed quantity, saving the result of the observation, subjecting each of the secret qubit and decoy qubits to the quantum operation of a randomly determined quantity for changing the quantum state of each qubit, and sequentially passing the n+1 pieces of qubits in an arbitrary order along the quantum channel;
on the receiver side, receiving these qubits, subjecting each of the secret qubit and decoy qubits to the quantum operation of a randomly determined quantity for changing the quantum state of each qubit, and passing the qubits along the quantum channel in order to return the qubits to the sender side; and
on the sender side, performing an observation of each decoy qubit, based on the manipulation quantity guessed by the same process as in the sender-side resending step, and saving an observation result;

on the sender side, the secret qubit is subjected to a reverse manipulation for canceling the entire encryption performed on the sender side, and then the secret qubit is transmitted;

on the receiver side, the secret qubit is subjected to a manipulation for canceling the entire encryption performed on the receiver side;

information about the quantities of the entire manipulations performed on each decoy qubit on the receiver side is given from the receiver to the sender through the classical channel; and

based on these quantities, the sender side determines whether or not the quantity of each manipulation performed on the decoy qubit has been correctly guessed, and checks for evidence of eavesdropping by using the observation results obtained in the case where the quantity was correctly guessed.

### BRIEF DESCRIPTION OF THE DRAWINGS

FIG. 1 is a conceptual diagram illustrating the communication procedure of a quantum cryptographic communication protocol according to the first embodiment of the present invention.

FIG. 2 is a conceptual diagram illustrating the communication procedure of a quantum cryptographic communication protocol according to the second embodiment of the present invention.

FIG. 3 is a conceptual diagram illustrating the communication procedure of a quantum cryptographic communication protocol according to the third embodiment of the present invention.

### EXPLANATION OF NUMERALS

1 . . . Sender
2 . . . Receiver
3 . . . Quantum Channel
4 . . . Classical Channel
5 . . . Eavesdropper

### BEST MODES FOR CARRYING OUT THE INVENTION

The following descriptions specifically illustrate the quantum cryptographic communication method according to the present invention with reference to the drawings.

### First Embodiment

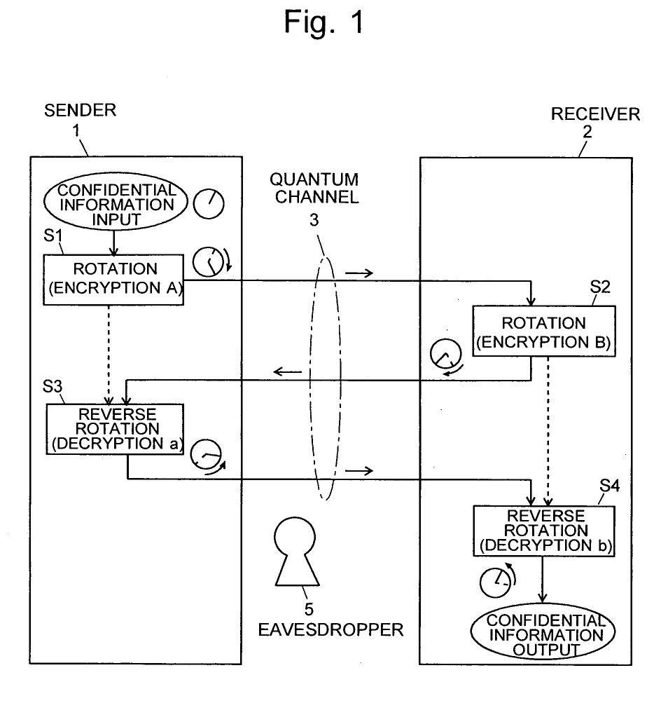

As an embodiment of the present invention, a quantum cryptographic communication protocol that forms the basis of the invention is described using FIG. 1, which is a conceptual diagram illustrating the quantum cryptographic communication protocol according to the first embodiment.

The sender 1 and receiver 2 are connected with each other through a quantum channel 3 capable of bi-directional communications. The purpose of communication in this example is to send confidential information from the sender 1 to the receiver 2 through the quantum channel 3. The quantum channel 3 bi-directionally transmits quantum-theoretical particles. The present embodiment assumes that photons are transmitted one by one so that each photon serves as one qubit. In this case, an optical fiber or similar optical transmission channel can be used as the quantum channel 3. The confidential information is represented by the polarization angle of a single photon. The communication procedure will be as follows.

[Step S1]

When a single photon having confidential information, i.e. a photon having a polarization angle corresponding to the confidential information, is inputted, the sender 1 randomly changes the polarization angle of the photon (a photon having confidential information is hereinafter called a “secret photon”). That is, the secret photon is rotated by a randomly selected angle. This rotational manipulation corresponds to an encryption by the sender 1 (“encryption A”), and the quantity of manipulation (i.e. the rotation angle) corresponds to the secret key of the encryption A. Each secret photon is separately encrypted and transmitted through the quantum channel 3 to the receiver 2. Therefore, the secret photon passing through the quantum channel 3 at this stage is coded by the encryption A.

[Step S2]

After the aforementioned single secret photon is received through the quantum channel 3, the receiver 2 randomly changes the polarization angle of the secret photon. That is, the secret photon is rotated by a randomly selected angle. This rotational manipulation corresponds to an encryption by the receiver 2 (“encryption B”), and the quantity of manipulation (i.e. the angle rotation) corresponds to the secret key of the encryption B. The secret photon thus encrypted is then returned through the quantum channel 3 to the sender 1. Therefore, the secret photon passing through the quantum channel 3 at this stage is double coded by the encryptions A+B.

[Step S3]

The sender 1 receives the returned secret photon and performs a manipulation for rotating the secret photon in the direction opposite to the previous direction so as to cancel the rotational manipulation performed by himself or herself in Step S1. This manipulation corresponds to decryption a for deciphering the code with the secret key used in the previous encryption A. However, even after the encryption A is cancelled by the sender 1, the effect of encryption B performed by the receiver 2 remains on the photon, since the received secret photon is double ciphered, as explained earlier. Therefore, the secret photon in this state is then resent through the quantum channel 3 to the receiver 2. As a result, the secret photon passing through the quantum channel 3 at this stage is coded by the encryption B.

[Step S4]

The receiver 2 receives the resent secret photon and performs a manipulation for rotating the secret photon in the direction opposite to the previous direction so as to cancel the rotational manipulation performed by himself or herself in Step S2. This manipulation corresponds to decryption b for deciphering the code with the secret key used in the previous encryption B. This operation restores the secret photon to its original state in which the polarization angle represents only the confidential information. This secret photon will be extracted and used, for example, as input to a quantum computer. Thus, the communication of one qubit is completed.

Now, let us consider whether a third party (eavesdropper) 5 can eavesdrop on the communication in the above quantum cryptographic communication protocol. According to the protocol, encrypted information is passed through the quantum channel 3, whereas the secret keys that are necessary for decryption will never be transmitted since these keys do not need to be shared by the sender 1 and the receiver 2. Therefore, it is in principle impossible for the eavesdropper 5 to obtain a secret key on the channel and decode the secret photon passing through the channel with that key.

If the difference in the polarization angle between the secret photon transmitted from the sender 1 in Step S1 and that returned from the receiver 2 in Step S2 could be computed, then the eavesdropper 5 would be able to derive the quantity of rotational manipulation performed by the receiver 2 (i.e. the secret key of the encryption B performed by the receiver 2). This information should make it possible to intercept the secret photon transmitted from the sender 1 in Step S4 and perform decryption on that photon to obtain confidential information. However, this trick is impossible because of the quantum-mechanical nature of the operation. That is, observation of the polarization angle of a photon is generally performed on the basis of its projections onto two orthogonal directions. Therefore, if the polarization angle of the photon to be observed is randomly determined, it is impossible to correctly determine the polarization angle. Furthermore, the quantum state of the photon will change even with a one-time observation. Due to these quantum-mechanical natures of the observation, the eavesdropper 5 cannot correctly know the quantity of the rotational manipulation performed by the receiver 2 and obtain confidential information by using the quantity information.

In the above quantum cryptographic communication protocol, not only classical information as in conventional cases but also quantum information itself can be placed on photons for transmission. It is of course evident that classical information can also be sent by associating two specific, orthogonal polarization angles with binary values of 0 and 1, respectively. It is also impossible for the eavesdropper 5 to observe a secret photon flowing through the quantum channel 3 and intercept the confidential information placed on the secret photon.

However, the previous protocol still leaves the possibility of impersonation; the eavesdropper 5 can impersonate the receiver 2 to receive information. Specifically, this can take place as follows: The eavesdropper 5, intervening between the sender 1 and the receiver 2, receives a secret photon transmitted in Step S1 and forwards it intact to the sender 1 without performing any rotational manipulation. Then, without knowing that the secret photon has been returned from the eavesdropper 5, the sender 1 performs the decryption a on the returned secret photon to cancel the previously performed encryption A and resends the secret photon. At this stage, the secret photon is totally decoded, so that the eavesdropper 5 receiving the photon can easily obtain the confidential information carried by the secret photon. Meanwhile, the eavesdropper 5 sends an appropriately prepared photon to the receiver 2 in place of the secret photon transmitted from the sender 1 in Step S1. Similarly, the interceptor can receive a photon returned from the receiver 2 in Step S2 and then send an appropriate photon in return.

The preceding discussion demonstrates that the quantum cryptographic communication protocol according to the first embodiment is highly secure against a simple eavesdropping activity on the quantum channel 3 but not so secure against impersonation. Given this factor, it is possible to modify the protocol to improve its resistance to impersonation. The following section illustrates an improved version of the protocol as the second embodiment.

### Second Embodiment

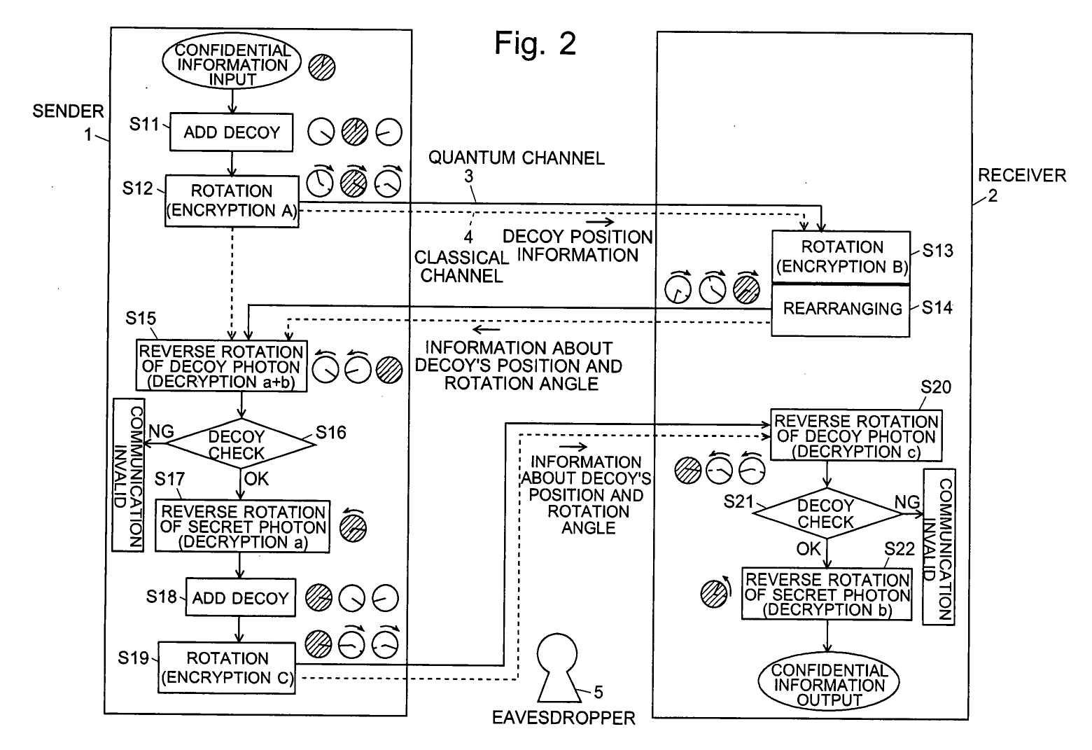

FIG. 2 is a conceptual diagram illustrating a quantum cryptographic communication protocol according to the second embodiment. The present embodiment shares the same basic concepts with the first embodiment in that the encryption and decryption of a photon are achieved by rotational and reverse-rotational manipulations, and in that no information corresponding to the secret keys used for encryption is transmitted through the channels. In addition, the protocol according to the second embodiment employs a decoy with the intention of confusing the eavesdropper 5. Sharing information about the decoy through a classical channel between the sender 1 and the receiver 2 enables them to detect the presence of an eavesdropper 5. The following description illustrates the communication procedure of this quantum cryptographic communication protocol, using FIG. 2.

[Step S11]

In the present example, two decoys (which are hereinafter called the decoy photons) each having a known initial quantum state (initial polarization angle) are prepared for each secret photon having confidential information. Their position, or the sequence of the three photons, can be arbitrarily chosen. For now, suppose that each secret photon is preceded by one decoy photon and followed by another. The initial polarization angle of each decoy photon can also be arbitrarily chosen. This angle is known exclusively by the sender 1.

[Step S12]

For these three photons, the sender 1 randomly changes the polarization angle of the secret photon and also that of each of the two decoy photons. That is, the sender applies the encryption A to each photon by performing a rotational manipulation on the photon. Now, let Ta1 denote the quantity of the manipulation performed on the secret photon and Ta2 and Ta3 denote the quantities of the manipulation performed on the two decoy photons, respectively. (Since each of the values Ta1, Ta2 and Ta3 is randomly selected, it is possible that Ta1=Ta2=Ta3, although its probability is low.) These values constitute the secret key of the encryption A. The three photons thus encrypted are then sent through the quantum channel 3 to the receiver 2. Therefore, the three photons passing through the quantum channel 3 at this stage are coded by the encryption A, and the order of the three photons is unknown to any party except by the sender 1.

[Step S13]

The receiver 2 sequentially receives the three photons 3 from the quantum channel 3 and temporarily holds them. After these photons are received, the receiver 2 refers to the sender 1 through a classical channel 4 to obtain information about the arrangement order of the three photons (the positional information of the decoy photons). The classical channel 4 may be constructed using a telephone, fax machine, electronic mail or any other conventional communication tools. Preferably, it should be an authenticated communication channel. After the arrangement order information is obtained, the receiver 2 recognizes the position of the decoy photons based on that information and then randomly changes the polarization angle of the secret photon and also that of each of the two decoy photons. That is, the receiver 2 performs the encryption B. Now, let Tb1 denote the quantity of the manipulation performed on the secret photon denoted and Tb2 and Tb3 denote the quantities of the manipulation performed on the two decoy photons, respectively. (Since each of the values Tb1, Tb2 and Tb3 is randomly selected, it is possible that Tb1=Tb2=Tb3, although its probability is low.) These values constitute the secret key of the encryption B.

[Step S14]

Subsequently, the receiver 2 changes the position of the decoys, i.e. the order of the three photons. For now, suppose that the secret photon has been moved to the third position by the position-changing operation. The three photons thus rearranged are then sequentially returned to the sender 1 through the quantum channel 3. Therefore, the three photons passing through the quantum channel 3 at this stage are double coded by the encryptions A+B, and the order of the three photons is unknown to any party except by the receiver 2.

[Step S15]

The sender 1 sequentially receives the returned three photons 3 and temporarily holds them. After these photons are received, the sender 1 refers to the receiver 2 through the classical channel 4 to obtain information about the arrangement order of the three photons (the positional information of the decoy photons) and also information about the quantities Tb2 and Tb3 of the manipulations performed on the two decoy photons. Based on the arrangement order information provided from the receiver 2, the sender 1 locates the two decoy photons and subjects each of them to a reverse-rotational manipulation for canceling the rotational manipulations (quantities: Ta2 and Ta3) performed by himself or herself in Step S12 and also the rotational manipulations (quantities: Tb2 and Tb3) performed by the receiver 2. That is, the receiver 2 performs the decryptions a and b on each of the two decoy photons.

[Step S16]

As explained earlier, according to the quantum theory, observing a photon inevitably changes the quantum state of the photon. Therefore, if the decoy photons have been neither observed nor manipulated by the eavesdropper 5 in the course of the communication, the quantum state of the decoy photons that have undergone the reverse-rotational manipulation should be perfectly identical to the initial quantum state of the decoy photons initially prepared by the sender 1. In other words, any discrepancy between the two states suggests that it is highly possible that the eavesdropper 5 has observed or manipulated the decoy photons in the course of the communication and thereby changed their quantum state. Accordingly, a check is performed as to whether the quantum state of the decoy photons that have been decoded in Step S15 is identical to their initial quantum state. If the two states differ, the communication will be invalidated, based on the judgment that there is probably an eavesdropper 5. On the other hand, if the quantum state of the decoded decoy photons is identical to their initial quantum state, the communication will be validated, based on the judgment that there is no eavesdropper 5, and the process goes to Step S17. Meanwhile, the decoded decoy photons are discarded.

[Step S17]

If the communication is valid, the sender 1 rotates the secret photon in the direction opposite to the previous direction so as to cancel the rotational manipulation performed by himself or herself in Step S12. That is, the decryption a is performed on the secret photon. However, even after the encryption A is cancelled by the sender 1, the effect of encryption B performed by the receiver 2 remains on the photon, since the secret photon is double coded, as explained earlier.

[Step S18]

For the secret photon that has undergone the decryption a, the sender 1 again prepares two decoy photons, whose initial quantum state is known exclusively to the sender 1, and places them in an appropriate position. This position can be arbitrarily chosen; for now, it is assumed that the two decoy photons follow the secret photon.

[Step S19]

The sender 1 randomly changes the polarization angle of each of the two decoy photons (the manipulation quantities are denoted by Tc2 and Tc3, respectively). That is, the sender performs encryption C by applying a rotational manipulation to each decoy photon. Tc2 and Tc3 constitute the secret key of the encryption C. The three photons that have resulted from the addition of the decoy photons and the application of the rotational manipulation are then sequentially returned to the receiver 2 through the quantum channel 3. At this stage, the decoy photons are coded by the encryption C and the secret photon by the encryption B.

[Step S20]

The receiver 2 sequentially receives the returned three photons 3 and temporarily holds them. After these photons are received, the receiver 2 refers to the sender 1 through the classical channel 4 to obtain information about the arrangement order of the three photons (the positional information of the decoy photons), the initial state of the two decoy photons, and the quantities Tc2 and Tc3 of manipulations of the encryption C performed on the decoy photons. Based on the arrangement order information provided from the receiver 2, the sender 1 locates the two decoy photons and subjects each of them to a reverse-rotational manipulation for canceling the rotational manipulations (quantities: Tc2 and Tc3) performed for the encryption C by the sender 1. That is, the receiver 2 performs the decryption c on each of the two decoy photons.

[Step S21]

As explained earlier, according to the quantum theory, observing a photon inevitably changes its quantum state. Therefore, if the decoy photons have been neither observed nor manipulated by the eavesdropper 5 in the course of the communication, the quantum state of the decoy photons that have undergone the reverse-rotational manipulation in Step S20 should be perfectly identical to the initial quantum state of the decoy photons about which the receiver has received information from the sender 1 through the classical channel 4. In other words, any discrepancy between the two states suggests that it is highly possible that the eavesdropper 5 has observed or manipulated the decoy photons in the course of the communication and thereby changed their quantum state. Accordingly, a check is performed as to whether the quantum state of each decoy photon that has been decoded in Step S20 is identical to its initial quantum state. If the two states differ, the communication will be invalidated, based on the judgment that there is probably an eavesdropper 5. On the other hand, if the quantum state of the decoded decoy photons is identical to their initial quantum state, the communication will be validated, based on the judgment that there is no eavesdropper 5, and the process goes to Step S22.

If the communication is valid, the receiver 2 rotates the secret photon in the direction opposite to the previous direction so as to cancel the rotational manipulation performed by himself or herself in Step S13. That is, the decryption b is performed on the secret photon. This operation restores the secret photon to its original state in which the polarization angle represents only the confidential information. This secret photon can be extracted and used, for example, as input to a quantum computer.

As described thus far, the quantum cryptographic communication protocol according to the second embodiment uses the quantum channel 3 together with the classical channel 4 (preferably, an authenticated one). The communication through the classical channel 4 may be eavesdropped on. However, since the sender 1 and the receiver 2 do not need to share the secret keys for encrypting (and decrypting) the secret photon, information corresponding to the secret keys (i.e. the manipulation quantities Ta1 and Ta2) will never flow through the classical channel 4 or through the quantum channel 3. Thus, high security is ensured as in the case of the quantum cryptographic communication protocol according to the first embodiment.

Furthermore, in the protocol according to the second embodiment, information about decoy photons is transmitted through the classical channel 4 after three photons including a secret photon are transmitted through the quantum channel 3. Accordingly, the eavesdropper 5 has to correctly guess the position of the secret photon among the three photons flowing through the quantum channel 3, in order to impersonate the receiver 2 in receiving and sending photons to and from the sender 1 and finally intercept confidential information, without being detected by the checking of decoy photons in both Steps S16 and S21. The probability of successful interception of confidential information by such impersonation is as low as 1 in 27 instances, since it is necessary to correctly guess the position of the secret photon among three photons three times: First, the position of the secret photon among three photons initially transmitted from the sender 1 must be correctly guessed; then, the position of the secret photon among three photons returned to the sender 1 must be correctly guessed (as intended by the receiver 2); and finally, the position of the secret photon among three photons returned to the receiver 2 must be correctly guessed (as intended by the sender 1). Thus, the quantum cryptographic communication protocol according to the second embodiment is resistant to impersonation. If the eavesdropper 5 is attempting to intercept information on the quantum channel 3, both the sender 1 and the receiver 2 can detect the attempt with high probability.

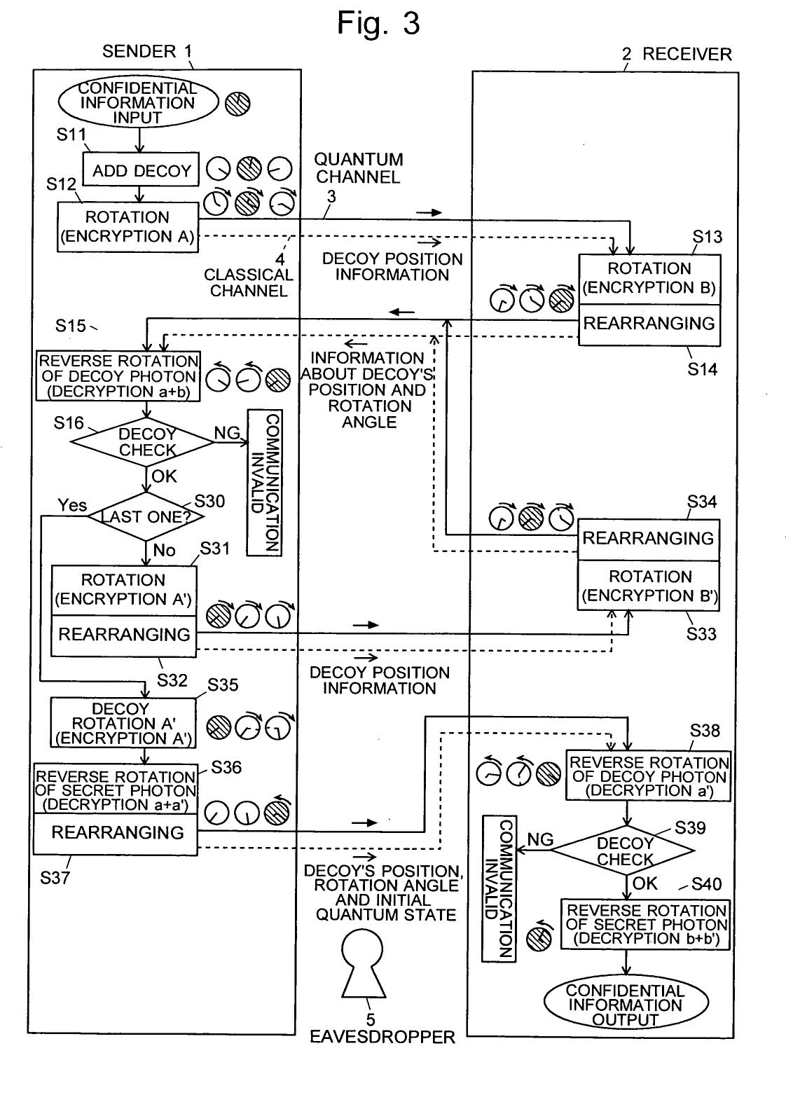

In the second embodiment, the decoy photons were used only for one and a half round-trip transmissions of the photons through the quantum channel 3 between the sender 1 and the receiver 2. This process can be modified to further increase the probability of detecting eavesdropping. This can be achieved by repeating the bi-directional transmission of the photons, including an encrypted secret photon accompanied by decoy photons, between the sender 1 and the receiver multiple times while changing the position of the decoy photons for every transmission, and checking the quantum state of the decoy photons for every one-way or round-trip transmission of the photons. Generally, repeating the transmission of encrypted information is not recommended for security reasons. However, in the present protocol, the aforementioned technique of improving the security is possible since no secret key flows through the channels. Accordingly, the following embodiment describes a quantum cryptographic communication protocol including the repetition of the bi-directional transmission of the photons, using FIG. 3.

### Third Embodiment

In the third embodiment, those steps which are identical or corresponding to those of the protocol in the second embodiment are denoted by the same step numbers. That is, the operations and processes in Steps S11 through S16 are the same as in the second embodiment. Therefore, these steps will not be explained in the following description.

[Steps S30 and S31]

If, in Step S16, the quantum state of the two decoy photons is identical to their initial quantum state, then whether or not the next transmission is the last one is determined, and if not the last one, the process goes to Step S31. In Step S31, a total of three photons, i.e. two decoy photons and one secret photon, are each encrypted by a rotational manipulation, as in Step S12. The quantities of this manipulation may or may not be equal to those of the encryption A. For the sake of distinction from the encryption A, the present encryption will be labeled A′.

[Step S32]

Subsequently, the three photons thus encrypted are appropriately rearranged and sent through the quantum channel 3 to the receiver 2. Therefore, among the three photons passing through the quantum channel 3 at this stage, the two decoy photons are coded by the encryption A′ while the secret photon is coded by the encryptions A+B+A′.

[Steps S33 and S34]

After the three photons are sequentially received, the receiver 2 holds the photons and then refers to the sender 1 through the classical channel 4 to obtain information about the arrangement order of the three photons, as in Step S13. Based on this arrangement order information, the sender 1 locates the decoy photons and performs an encryption by randomly rotating each photon. The quantities of this manipulation may or may not be equal to those of the encryption B. For the sake of distinction from the encryption B, the present encryption will be labeled B′. Subsequently, the three photons are rearranged and sequentially sent through the quantum channel 3 to the sender 1, as in Step S14. Therefore, among the three photons passing through the quantum channel 3 at this stage, the two decoy photons are coded by the encryptions A′+B′ while the secret photon is coded by the encryptions A+B+A′+B′.

The processes to be performed by the sender 1 after the three photons resent from the sender 1 are received are similar to those in Steps S15 and S16, except that the decryptions performed on the decoy photons are not intended to cancel the encryptions A+B but the encryptions A′+B′. If the quantum state of the decoy photons is identical to their initial quantum state, the previously described processes are similarly repeated. However, it should be noted that the manipulation quantities for the encryptions A′ and B′ be randomly determined for every repetition. Thus, one operational cycle is completed as follows: S15→S16→S30→S31→S32→S33→S34∵S15. Through this cycle, the photons make a round trip through the quantum channel 3, during which the quantum state of the decoy photons are checked one time. The number of repetitions can be arbitrarily determined beforehand. Alternatively, in Step S30, the sender 1 may randomly decide whether to proceed to Step S31 to repeat the process once more or to Step S35 to perform the final transmission.

[Steps S35, S36 and S37]

After the previously described processes have been repeated an appropriate number of times and the next transmission is determined to be the last one, the judgment in Step S30 will be “Yes” and the process will go to Step S35. In this step, the encryption A′ is applied to the two decoy photons by performing a rotational manipulation of a randomly determined quantity on each decoy photon. On the other hand, the secret photon is subjected to decryption for entirely canceling all the encryptions performed by the sender 1. For example, if the secret photon is coded by the encryptions A+B+A′+B′, the decryption a+a′ will be performed so that only the effects of the encryptions B+B′ will remain on the secret photon. Then, the three photons are appropriately rearranged and passed along the quantum channel 3. Among the three photons passing through the quantum channel 3 at this stage, the two decoy photons are coded by the encryption A′ while the secret photon is coded by all the encryptions performed by the receiver 2.

[Step S38, S39 and S40]

After the three photons are received, the receiver 2 refers to the sender 1 through the classical channel 4 to obtain information about the position of the decoy photons, the quantities of the manipulations performed on the decoy photons and the initial quantum state of the decoy photons. Based on these pieces of information, the receiver 2 locates the decoy photons and performs the decryption a′. The quantum state of the decoded decoy photons should be identical to their initial quantum state if they have not undergone observation, cloning or any other manipulation by the eavesdropper 5 en route from the sender 1. Accordingly, a check is performed as to whether the quantum state of the decoy photons is identical to their initial quantum state. If the two states differ, the communication will be invalidated. On the other hand, if the quantum state of the decoded decoy photons is identical to their initial quantum state, the receiver 2 will perform decryption for canceling the entire encryptions previously performed by the receiver. For example, the decryption b+b′ will be performed if the photons are coded by the encryptions B+B′. This decryption restores the secret photon to its original state in which the polarization angle represents only the confidential information. This secret photon will be extracted and used, for example, as input to a quantum computer.

As described thus far, in the quantum cryptographic communication protocol according to the third embodiment, one secret photon and two decoy photons make a round trip through the quantum channel 3 once or multiple times. The secret photon is always encrypted whenever it is in transmission, and the secret keys for encrypting (and decrypting) the secret photon are not passed through the classical channel 4 or through the quantum channel 3. The eavesdropper 5 has to correctly guess the position of the secret photon among the three photons every time they are transmitted. Therefore, repeating the round-trip transmission increases the possibility of mistaking a decoy photon for the secret one. Thus, the probability of detecting eavesdropping is considerably enhanced.

The quantum cryptographic communication protocols according to the first through third embodiments are also resistant to the photon number splitting attack. The can be reasoned as follows. In principle, a quantum communication using photons requires the sender to separately transmit a single photon and the receiver to receive this single photon. The so-called no-cloning theorem states that in the world of quantum theory it is impossible to create an exact copy of information. Therefore, if the sender 1 sends a specific single photon, it is impossible for the eavesdropper 5 to intercept the photon, keep it at hand, and later send another photon to the receiver 2; in such a case, the receiver 2 will perceive with high probability that the photon has been intercepted in the course of the transmission. However, it is technically difficult for actual hardware devices to send a specific single photon; transmitters will inevitably produce multiple photons having the same information and pass them along communication channels. If multiple photons are thus transmitted through the quantum channel 3, the eavesdropper 5 has only to intercept one of the multiple photons and let the other reach the receiver 2 intact (this is the photon number splitting). Thus, the impossibility of creating an exact copy no longer impedes eavesdropping.

However, even if the eavesdropper 5 has intercepted a photon without being noticed by the sender 1 and the receiver 2, he or she cannot access the confidential information without using the secret decryption keys. The quantum cryptographic communication protocols according to the first through third embodiments are all characterized in that the secret decryption keys will pass through neither the quantum channel 3 nor the classical channel 4. Even if the eavesdropper 5 can intercept one or more photons by a photon number splitting attack, it is impossible to crack the code since the interceptor cannot obtain the secret keys. Thus, a security level against the photon number splitting attack is also ensured by preventing the secret decryption keys from being transmitted through the channels.

There are many other variations for explaining the previously mentioned protocols in concrete forms. For example, in the previous embodiments, a rotational manipulation for changing the polarization angle of a photon was performed to encrypt a qubit. However, the encryption can be achieved using other techniques for changing the quantum state of the qubit. One such example is a generally known quantum operation that is expressed by a matrix operation in which a qubit is multiplied by the following matrices I, X, Z and XZ:

$$I = ( \begin{matrix}1 & 0 \\ 0 & 1\end{matrix} ) , \\ X = ( \begin{matrix}0 & 1 \\ 1 & 0\end{matrix} ) , \\ Z = ( \begin{matrix}1 & 0 \\ 0 & - 1\end{matrix} ) , \\ XZ = ( \begin{matrix}0 & - 1 \\ 1 & 0\end{matrix} ) .$$

Accordingly, it is possible to use a quantum operation in which a qubit is multiplied by a matrix selected from a plurality of matrices prepared beforehand.

In the quantum cryptographic communication protocols according to the second and third embodiments, after the photons are received, both the sender 1 and receiver 2 have to obtain additional information (i.e. information about the decoys) by an inquiry through the classical channel 4 and perform a quantum operation using the information. For this purpose, a quantum memory for storing received photons while maintaining their quantum state is required. If such a quantum memory is not available at relatively low costs on a practical level, it will possibly be difficult to implement the protocol in actual systems. Accordingly, in order to make the quantum memory unnecessary, the protocol according to the third embodiment may be modified as follows:

After the three photons are received, the receiver 2 performs only the random rotational manipulation on these photons and returns them without changing their arrangement order (i.e. without performing the process of Step S14). Therefore, the receiver 2 does not have to wait for information to be provided from the sender 1 through the classical channel 4. On the other hand, upon receiving the returned photons, the sender 1 appropriately guesses the quantities of the rotational manipulations performed by the receiver 2, without asking the receiver 2 for information about the manipulation quantities Tb2 and Tb3. Based on the guess, the sender 1 then observes the polarization angles of the decoy photons and saves the result. At this stage, the result is simply saved; no check is performed as to whether the observed state is identical to the initial quantum state. Such a bi-directional transmission of the photons is performed once or multiple times, during which the receiver 2 does not rearrange the three photons while the sender 1 observes the polarization angles of the decoy photons, based on his or her guess of the quantities of the manipulations performed by the receiver 2, and saves the result. Since the classical channel 4 is not used throughout this process, it is unnecessary to provide a quantum memory that is intended to store the photons' quantum state until the provision of information through the classical channel 4 is completed.

At the last stage, the sender 1 performs decryption for canceling the entire encryptions previously performed on the secret photon by the sender and transmits the photon to the receiver 2. The receiver 2 similarly performs decryption for canceling the entire encryptions previously performed on the secret photon by the receiver and thereby obtains the confidential information. Finally, the sender 1 sends information about the arrangement order of the three photons (i.e. the positional information of the secret photon and the decoy photons) to the receiver 2 through the classical channel 4. From this information, the receiver 2 recognizes where the decoy photons were located during the previous bi-directional transmission, and then informs the sender 1, through the classical channel 4, of all the quantities (Tb2 and Tb3) of the manipulations performed on the decoy photons at each stage. Upon receiving this information, the sender 1 determines whether he or she has correctly guessed the quantities of rotational manipulations when checking the decoy photons at each stage, and leaves only the observation results obtained at the stages where the guess was correct and discards the other results. For each of the remaining observation results, the sender 1 determines whether the state of the decoy photons was identical to their initial quantum state. If there is a decoy photon whose state differed from the initial quantum state, there should be an eavesdropper 5; if there is no decoy photon whose state was identical to the initial quantum state, there should be no eavesdropper 5.

In this method, the presence of an eavesdropper 5 is finally checked after the secret photon having confidential information is transmitted to the receiver 2. The presence of the eavesdropper 5 will be eventually detected, although the eavesdropper 5 is given a chance of intercepting confidential information by impersonation. On this point, the method does not guarantee unconditional security. However, the method is advantageous in terms of implementation since it does not require a quantum memory which is otherwise necessary for the sender 1 and receiver 2 to store the received photons with their quantum state maintained intact and then wait for the arrival of information from the other party through the classical channel 4.

In the previous embodiments, the confidential information was placed on one photon. Alternatively, a so-called quantum secret sharing scheme may be used so that the quantum state itself that a single photon (qubit) can have will be shared by multiple photons (qubits). In this case, the confidential information cannot be extracted from any single photon; the information cannot be obtained unless all the photons sharing the confidential information are available. Thus, the security level is further enhanced.

It should be noted that the foregoing embodiments are mere examples. It is evident that any changes or modifications to those embodiments within the spirit of the present invention will also be included in the scope of the claims of the present patent application.

1. A quantum cryptographic communication method for performing communication using quantum cryptography in sending confidential information from a sender side to a receiver side through a communication channel, wherein:
a photon is used as a qubit;
a rotational manipulation for changing a polarization angle of the photon is used as a quantum operation for changing a quantum state of the qubit; and
following steps are sequentially performed:
a sender-side sending step, including: subjecting a single secret qubit with confidential information placed thereon to encryption by the quantum operation of a randomly determined quantity for changing the quantum state of the secret qubit, and then passing the secret qubit along a quantum channel in order to send the secret qubit to the receiver side;
a receiver-side returning step, including: subjecting the secret qubit received through the quantum channel to encryption by the quantum operation of a randomly determined quantity for changing the quantum state of the secret qubit, and then passing the secret qubit along the quantum channel in order to return the secret qubit to the sender side;
a sender-side resending step, including: subjecting the secret qubit returned to the sender side to a reverse manipulation by the aforementioned quantity for decrypting the encryption performed earlier on the sender side, and then passing the secret qubit along the quantum channel in order to resend the secret qubit to the receiver side; and
a receiver-side receiving step, including: subjecting the secret qubit received through the quantum channel to a reverse manipulation by the aforementioned quantity for decrypting the encryption performed earlier on the receiver side, and then obtaining the confidential information placed on by the qubit.

2. A quantum cryptographic communication method for performing communication using quantum cryptography in sending confidential information from a sender side to a receiver side through a communication channel, wherein:
a photon is used as a qubit;
a manipulation represented by a matrix operation in which the qubit is multiplied by one of a plurality of matrices prepared beforehand is used as a quantum operation for changing a quantum state of the qubit; and
following steps are sequentially performed:
a sender-side sending step, including: subjecting a single secret qubit with confidential information placed thereon to encryption by the quantum operation of a randomly determined quantity for changing the quantum state of the secret qubit, and then passing the secret qubit along a quantum channel in order to send the secret qubit to the receiver side;
a receiver-side returning step, including: subjecting the secret qubit received through the quantum channel to encryption by the quantum operation of a randomly determined quantity for changing the quantum state of the secret qubit, and then passing the secret qubit along the quantum channel in order to return the secret qubit to the sender side;
a sender-side resending step, including: subjecting the secret qubit returned to the sender side to a reverse manipulation by the aforementioned quantity for canceling the encryption performed earlier on the sender side, and then passing the secret qubit along the quantum channel in order to resend the secret qubit to the receiver side; and
a receiver-side receiving step, including: subjecting the secret qubit received through the quantum channel to a reverse manipulation by the aforementioned quantity for canceling the encryption performed earlier on the receiver side, and then obtaining the confidential information placed on by the qubit.

3. The quantum cryptographic communication method according to claim 1, wherein:
an authenticated classical channel through which a sender and a receiver can communicate with each other is provided in addition to the quantum channel;
the sender-side sending step includes: preparing n pieces of decoy qubits (where n is an integer including one) for each secret qubit, subjecting each decoy qubit to the quantum operation of a randomly determined quantity for changing the quantum state of each qubit, and sequentially passing a total of n+1 pieces of qubits in an arbitrary order along the quantum channel;
the receiver-side returning step includes: receiving the n+1 pieces of qubits through the quantum channel, then obtaining bit sequence information from the sender through the classical channel, subjecting each of the secret qubit and decoy qubits to the quantum operation of a randomly determined quantity for changing the quantum state of each qubit, and passing the qubits in an arbitrarily rearranged order along the quantum channel in order to return them to the sender side; and
the sender-side resending step includes: receiving the n+1 pieces of qubits through the quantum channel, then obtaining bit sequence information and quantity information of the manipulation performed on each decoy qubit from the receiver through the classical channel, decoding each decoy qubit by a reverse manipulation for canceling both the quantum operation performed earlier on the sender side and the quantum operation performed on the receiver side, and checking for evidence of eavesdropping by determining whether or not the quantum state of the decoded decoy qubit is identical to the initial quantum state thereof.

4. The quantum cryptographic communication method according to claim 3, wherein the n+1 pieces of qubits are bi-directionally transmitted through the quantum channel multiple times by repeating following steps:
subjecting each of the secret qubit and decoy qubits to the quantum operation of a randomly determined quantity for changing the quantum state of each qubit, and then sequentially passing the n+1 pieces of qubits in an arbitrarily rearranged order along the quantum channel, if no evidence of eavesdropping has been found in the sender-side resending step;
on the receiver side, receiving the qubits, then obtaining bit sequence information from the sender through the classical channel, subjecting each of the secret qubit and decoy qubits to the quantum operation of a randomly determined quantity for changing the quantum state of each qubit, and sequentially passing the qubits in an arbitrarily rearranged order along the quantum channel in order to return the qubits to the sender side; and
on the sender side, checking for evidence of eavesdropping by the same process as in the sender-side resending step.

5. The quantum cryptographic communication method according to claim 4, comprising:
on the sender side, in the case of no detection of an eavesdropping activity a predetermined number of times in series, subjecting the secret qubit to a reverse manipulation for canceling the entire encryption performed earlier on the sender side and each decoy qubit to the quantum operation of an arbitrary quantity for changing the quantum state of the decoy qubit, and then sequentially passing the n+1 pieces of qubits including the secret qubit in an arbitrary order along the quantum channel; and
on the receiver side, receiving the aforementioned qubits, then obtaining information about the qubit sequence, the quantity of the manipulation performed on each decoy qubit, and an initial quantum state of each decoy qubit from the sender, decoding each decoy qubit by a reverse manipulation for canceling the quantum operation performed by the sender, then checking for evidence of eavesdropping by determining whether or not the quantum state of the decoded decoy qubit is identical to the initial quantum state thereof, and subjecting the secret qubit to a reverse manipulation for canceling the entire encryption performed on the receiver side, if no evidence of eavesdropping has been found.

6. The quantum cryptographic communication method according to claim 1, wherein:
an authenticated classical channel through which a sender and a receiver can communicate with each other is provided in addition to the quantum channel;
n+1 pieces of qubits (where n is an integer) are sent and received through the quantum channel multiple times by repeating following steps:
in the sender-side sending step, preparing n pieces of decoy qubits for each secret qubit, subjecting each of the secret qubit and decoy qubits to the quantum operation of a randomly determined quantity for changing the quantum state of each qubit, and sequentially passing a total of n+1 pieces of qubits in an arbitrary order along the quantum channel;
in the receiver-side returning step, receiving the n+1 pieces of qubits through the quantum channel, then subjecting each qubit to the quantum operation of a randomly determined quantity for changing the quantum state of each qubit, and passing the qubits along the quantum channel in order to return the qubits to the sender side;
in the sender-side resending step, receiving the n+1 pieces of qubits through the quantum channel, then guessing the quantity of the manipulation performed on each decoy qubit on the receiver side, performing an observation based on the guessed quantity, saving a result of the observation, subjecting each of the secret qubit and decoy qubits to the quantum operation of a randomly determined quantity for changing the quantum state of each qubit, and sequentially passing the n+1 pieces of qubits in an arbitrary order along the quantum channel;
on the receiver side, receiving these qubits, subjecting each of the secret qubit and decoy qubits to the quantum operation of a randomly determined quantity for changing the quantum state of each qubit, and passing the qubits along the quantum channel in order to return the qubits to the sender side; and
on the sender side, performing an observation of each decoy qubit, based on the manipulation quantity guessed by the same process as in the sender-side resending step, and saving an observation result;
on the sender side, the secret qubit is subjected to a reverse manipulation for canceling the entire encryption performed on the sender side, and then the secret qubit is transmitted;
on the receiver side, the secret qubit is subjected to a manipulation for canceling the entire encryption performed on the receiver side;
information about the quantities of the entire manipulations performed on each decoy qubit on the receiver side is given from the receiver to the sender through the classical channel; and
based on these quantities, the sender side determines whether or not the quantity of each manipulation performed on the decoy qubit has been correctly guessed, and checks for evidence of eavesdropping by using the observation results obtained in the case where the quantity was correctly guessed.

7. The quantum cryptographic communication method according to claim 2, wherein:
an authenticated classical channel through which a sender and a receiver can communicate with each other is provided in addition to the quantum channel;
the sender-side sending step includes: preparing n pieces of decoy qubits (where n is an integer including one) for each secret qubit, subjecting each decoy qubit to the quantum operation of a randomly determined quantity for changing the quantum state of each qubit, and sequentially passing a total of n+1 pieces of qubits in an arbitrary order along the quantum channel;
the receiver-side returning step includes: receiving the n+1 pieces of qubits through the quantum channel, then obtaining bit sequence information from the sender through the classical channel, subjecting each of the secret qubit and decoy qubits to the quantum operation of a randomly determined quantity for changing the quantum state of each qubit, and passing the qubits in an arbitrarily rearranged order along the quantum channel in order to return them to the sender side; and
the sender-side resending step includes: receiving the n+1 pieces of qubits through the quantum channel, then obtaining bit sequence information and quantity information of the manipulation performed on each decoy qubit from the receiver through the classical channel, decoding each decoy qubit by a reverse manipulation for canceling both the quantum operation performed earlier on the sender side and the quantum operation performed on the receiver side, and checking for evidence of eavesdropping by determining whether or not the quantum state of the decoded decoy qubit is identical to the initial quantum state thereof.

8. The quantum cryptographic communication method according to claim 7, wherein the n+1 pieces of qubits are bi-directionally transmitted through the quantum channel multiple times by repeating following steps:
subjecting each of the secret qubit and decoy qubits to the quantum operation of a randomly determined quantity for changing the quantum state of each qubit, and then sequentially passing the n+1 pieces of qubits in an arbitrarily rearranged order along the quantum channel, if no evidence of eavesdropping has been found in the sender-side resending step;
on the receiver side, receiving the qubits, then obtaining bit sequence information from the sender through the classical channel, subjecting each of the secret qubit and decoy qubits to the quantum operation of a randomly determined quantity for changing the quantum state of each qubit, and sequentially passing the qubits in an arbitrarily rearranged order along the quantum channel in order to return the qubits to the sender side; and
on the sender side, checking for evidence of eavesdropping by the same process as in the sender-side resending step.

9. The quantum cryptographic communication method according to claim 8, comprising:
on the sender side, in the case of no detection of an eavesdropping activity a predetermined number of times in series, subjecting the secret qubit to a reverse manipulation for canceling the entire encryption performed earlier on the sender side and each decoy qubit to the quantum operation of an arbitrary quantity for changing the quantum state of the decoy qubit, and then sequentially passing the n+1 pieces of qubits including the secret qubit in an arbitrary order along the quantum channel; and
on the receiver side, receiving the aforementioned qubits, then obtaining information about the qubit sequence, the quantity of the manipulation performed on each decoy qubit, and an initial quantum state of each decoy qubit from the sender, decoding each decoy qubit by a reverse manipulation for canceling the quantum operation performed by the sender, then checking for evidence of eavesdropping by determining whether or not the quantum state of the decoded decoy qubit is identical to the initial quantum state thereof, and subjecting the secret qubit to a reverse manipulation for canceling the entire encryption performed on the receiver side, if no evidence of eavesdropping has been found.

10. The quantum cryptographic communication method according to claim 2, wherein:
an authenticated classical channel through which a sender and a receiver can communicate with each other is provided in addition to the quantum channel;
n+1 pieces of qubits (where n is an integer) are sent and received through the quantum channel multiple times by repeating following steps:
in the sender-side sending step, preparing n pieces of decoy qubits for each secret qubit, subjecting each of the secret qubit and decoy qubits to the quantum operation of a randomly determined quantity for changing the quantum state of each qubit, and sequentially passing a total of n+1 pieces of qubits in an arbitrary order along the quantum channel;
in the receiver-side returning step, receiving the n+1 pieces of qubits through the quantum channel, then subjecting each qubit to the quantum operation of a randomly determined quantity for changing the quantum state of each qubit, and passing the qubits along the quantum channel in order to return the qubits to the sender side;
in the sender-side resending step, receiving the n+1 pieces of qubits through the quantum channel, then guessing the quantity of the manipulation performed on each decoy qubit on the receiver side, performing an observation based on the guessed quantity, saving a result of the observation, subjecting each of the secret qubit and decoy qubits to the quantum operation of a randomly determined quantity for changing the quantum state of each qubit, and sequentially passing the n+1 pieces of qubits in an arbitrary order along the quantum channel;
on the receiver side, receiving these qubits, subjecting each of the secret qubit and decoy qubits to the quantum operation of a randomly determined quantity for changing the quantum state of each qubit, and passing the qubits along the quantum channel in order to return the qubits to the sender side; and
on the sender side, performing an observation of each decoy qubit, based on the manipulation quantity guessed by the same process as in the sender-side resending step, and saving an observation result;
on the sender side, the secret qubit is subjected to a reverse manipulation for canceling the entire encryption performed on the sender side, and then the secret qubit is transmitted;
on the receiver side, the secret qubit is subjected to a manipulation for canceling the entire encryption performed on the receiver side;
information about the quantities of the entire manipulations performed on each decoy qubit on the receiver side is given from the receiver to the sender through the classical channel; and
based on these quantities, the sender side determines whether or not the quantity of each manipulation performed on the decoy qubit has been correctly guessed, and checks for evidence of eavesdropping by using the observation results obtained in the case where the quantity was correctly guessed.
